(19) United States
(12) Patent Application Publication
(10) Pub. No.: US 2004/0105676 A1
(43) Pub. Date: Jun. 3, 2004

(54) Video delivering system and video delivering device for vehicle

(76) Inventors: Akira Norizuki, Shizuoka-ken (JP); Takamichi Kudo, Shizuoka-ken (JP)

Correspondence Address: Finnegan, Henderson, Farabow,, Garrett & Dunner, L.L.P., 1300 I Street, N.W., Washington, DC, 20005-3315, US

(21) Appl. No.: 10/648,298

(22) Filed: Aug. 27, 2003

(30) Foreign Application Priority Data
Aug. 28, 2002 (JP) 2002-249372

(51) Int. Cl. H04J 14/00

(52) U.S. Cl. 398/68

(57) ABSTRACT

A system S1 according to the invention comprises: a DVD unit 31 and a navigation unit 32, which generate video data; a ring-type network 1 in which a plurality of units are connected with one another in a ring shape and data is sent and received between the units adjacent to each other; and a branch network 2 which is connected through a gateway unit 3 being provided between the ring-type network 1 and the branch network 2, and including video display units 23, 24 and 25 which show the data from the DVD unit 31/navigation unit 32. By gateway unit 3, data is sent and received between the units adjacent to each other in the ring-type network 1 and video data generated in the DVD unit 31 and the navigation unit 32 is delivered to the branch network 2.

### CROSS REFERENCE TO RELATED APPLICATIONS

This application is based upon and claims the benefit of priority from the prior Japanese Patent Applications No. P2002-249372, filed on Aug. 28, 2002; the entire contents of which are incorporated herein by reference.

### BACKGROUND OF THE INVENTION

1. Field of the Invention

The invention relates to a video delivering system and a video delivering device for vehicle use, by which video data is delivered to a on-vehicle display unit by use of optical communication lines disposed in a vehicle.

2. Description of the Related Art

Conventionally, there has been known, for example, a video delivering system for vehicle use, in which a DVD (digital versatile disc or digital video disc) unit 201, a navigation unit 202, a display unit 203 installed at the front part of a vehicle, and a display unit 204 installed on the rear part of the vehicle are connected with one another in a ring shape as shown in FIG. 1. In the video delivering system for vehicle use, the above units are connected with one another using plastic optical fibers (POFs) 205, and synchronously send and receive digital data with a transmission bit rate of the order of several tens Mbps between the units.

Since the transmission bit rate of such a video delivering system for vehicle use is of the order of several tens Mbps, the DVD unit 201 and the navigation unit 202 are connected to the display units 203 and 204, respectively, using analog lines 206 in order to display video data, which is generated in the DVD unit 201 and the navigation unit 202, on the display units 203, 204, respectively.

FIG. 2 shows another conventional video delivering system for vehicle use. Since such a system uses plastic optical fibers (POFs) 205, the transmission bit rate of such a video delivering system for vehicle use is of the order of several tens Mbps. As shown in FIG. 2 the DVD unit 201 and the navigation unit 202 are provided with image compression sections 211, 212, respectively, and the display units 203, 204 comprise image expansion sections 213, 214, respectively, in the above system. In such a video delivering system for vehicle use, pictures generated in the DVD unit 201 and the navigation unit 202 are configured to be able to be displayed by compression and expansion in each unit on the display units 203, 204, respectively.

However, in the video delivering system for vehicle use shown in FIG. 1, the weight of a wire harnesses has been increased, because the analog lines 206 are required to be provided, other than the plastic optical fibers 205 and to be accommodated in the wire harnesses.

Also, in the video delivering system for vehicle use shown in FIG. 2, the cost for each unit (node) forming the system has been increased, because functions for the image compression and the image expansion are required to be installed in each unit.

Moreover, there has been other problems in the conventional video delivering systems for vehicle use, that arrangement of the wire harnesses in the vehicle becomes complex in many cases, and, furthermore, that communication among all the units forming the system can not be maintained by disconnection at one of the plastic optical fibers 205, because each unit forming the system is connected with one another in a ring shape by the plastic optical fibers 205.

The invention has been made, considering the above circumstances, and its object is to provide a video delivering system and a video delivering device for vehicle use, by which arrangement of the wire harnesses in the vehicle becomes easy and breakdowns in communication among all the components in the system can be avoided at disconnection on a transmission line.

### SUMMARY OF THE INVENTION

The first aspect of the present invention is that a video delivering system for vehicle use according to the invention comprises: a video acquisition unit which acquires video data; a ring-type network which is connected to the video acquisition unit, and in which a video delivering device for sending and receiving data to and from the video acquisition unit and a plurality of units connected to the video delivering device are connected with one another in a ring shape and data is sent and received between the units adjacent to each other; and a branch network which is connected to the video delivering device, and in which video data acquired in the video generation unit is sent to at least one of video display units through the video delivering device.

### BRIEF DESCRIPTION OF THE DRAWINGS

FIG. 1 is a block diagram showing a configuration of a conventional video delivering system for vehicle use;

FIG. 2 is a block diagram showing a configuration of another conventional video delivering system for vehicle use;

FIG. 3 is a block diagram showing a configuration of a video delivering system for vehicle use according to a first embodiment of the invention;

FIG. 4 is a block diagram showing a configuration of a gateway unit in the video delivering system for vehicle use according to the first embodiment of the invention;

FIG. 5 is an explanatory view of a frame structure of a packet for delivering video data;

FIG. 6 is an explanatory view of a specific configuration example of an optical coupler;

FIG. 7 is an explanatory view of a specific configuration example of another optical coupler;

FIG. 8 is a block diagram showing a configuration for a front display unit, rear display units;

FIG. 9 is a block diagram showing a configuration of a video delivering system for vehicle use according to a second embodiment of the invention;

FIG. 10 is a block diagram showing a configuration of a gateway unit in the video delivering system for vehicle use according to the second embodiment of the invention;

FIG. 11 is an explanatory view of a flow for displaying a picture taken with a monitoring camera on a rear display unit;

FIG. 12 is an explanatory view of a flow for displaying a DVD picture on a simplified display unit;

FIG. 13 is a block diagram showing a configuration of a video delivering system for vehicle use according to a third embodiment of the invention;

FIG. 14 is a view showing an optical configuration of a wavelength multiplexing coupler; and

FIG. 15 is a block diagram showing a configuration of a front display unit, rear display units in the video delivering system for vehicle use according to the third embodiment of the invention.

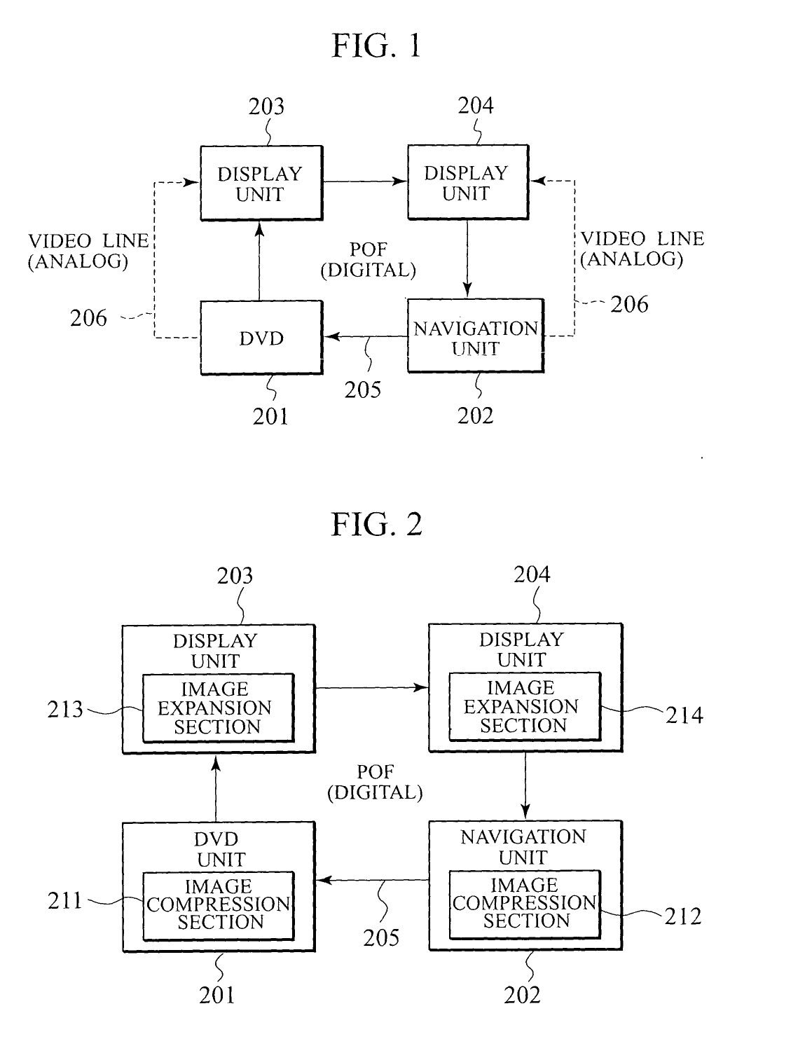

### DETAILED DESCRIPTION OF THE INVENTION

Hereinafter, video delivering systems for vehicle use according to a first through a third embodiments of the invention will be explained, referring to drawings.

[First Embodiment]

[Configuration of a Video Delivering System for Vehicle use According to the First Embodiment]

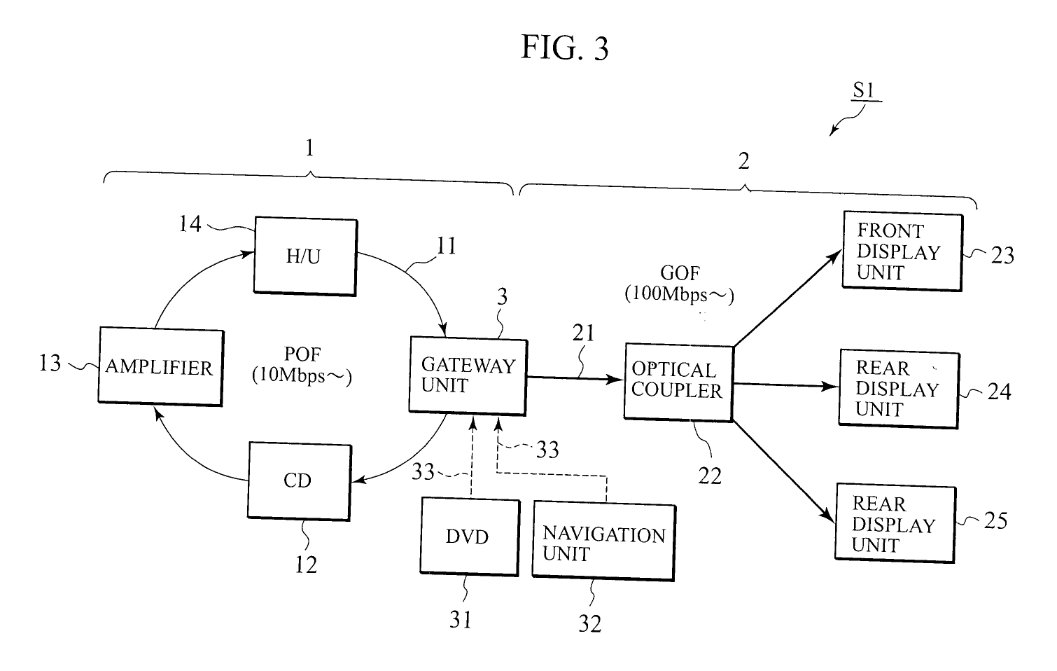

A video delivering system S1 for vehicle according to the first embodiment has a configuration, as shown in FIG. 3, in which a ring-type network 1 and a branch network 2 are connected to each other through a gateway unit 3 (video delivering device) and the sections are installed in the vehicle. Here, the gateway unit 3 is arranged as a component in the ring-type network 1 and is connected to a DVD unit 31, a navigation unit 32 and the like, which are a video generation unit, through analog lines 33.

The ring-type network 1 has a configuration in which the gateway unit 3, a CD reading unit 12 (hereinafter, called as a CD unit) which reads music information from a CD (Compact Disc) (not shown in the drawings) which is installed in the vehicle and is a sound source, an amplifier 13, and a head unit (H/U) 14 are connected with one another in a ring shape through plastic optical fibers (POF) 11.

On the other hand, the branch network 2 comprises an optical coupler 22 connected to the gateway unit 3 through a glass optical fiber 21 (GOF) including multi component glass, and a front display unit 23, and rear display units 24, 25, which are connected to the optical coupler 22. As shown in FIG. 3 the front display unit 23, and the rear display units 24, 25 are not directly connected to each other, but they are connected through the optical coupler 22.

In the video delivering system S1 for vehicle use, the plastic optical fibers 11 and the glass fibers 21 are accommodated in wire harnesses (not shown in the drawings), which are disposed in the vehicle, together with other electric wires and the like. Also, in the video delivering system S1 for vehicle use the front display unit 23 is accommodated in an instrument panel, the rear display units 24, 25 are accommodated in the back of a front seat or on a roof, at which the units can been seen from a back seat, and the glass fibers 12 are arranged in the instrument panel, the seat, or the roof from the harnesses.

In the ring-type network 1, communications between each unit are performed with a transmission bit rate of the order of several tens Mbps by transmission lines comprising the plastic optical fibers 11. At this time, the units forming the ring-type network 1 relay, send and receive packets in a simultaneous manner with each other in the direction of the arrows shown in the drawing, using a built-in communication IC.

A case in which in the ring-type network 1 for example, the head unit (H/U) 14 is operated to send sound data from the CD unit 12 to the amplifier 13 and sounds come out from a speaker (not shown in the drawing) will be explained.

Firstly, switch information input through operation of the head unit 14 by an occupant is stored in packets and the packets are sent to the CD unit 12. Then, when the CD unit 12 receives the packets storing the switch information through the gateway unit 3, the unit 12 reads the information after the unit 12 recognizes that the packets are addressed to the unit 12 itself. Subsequently, the CD unit 12 reads the sound data from installed recording media (CD) according to the switch information (for example, an instruction to reproduce a first track of the CD) and stores the sound data in packets. Thereafter, the packets including the sound data is sent to the amplifier 13. And, the amplifier 13 recognizes that the received packets has been addressed to the unit 13 itself and reads the sound data from the packets for driving the speaker (not shown in the figure) and reproducing sounds.

The DVD unit 31 and the navigation unit 32 for reading information recorded on DVD, which is installed on the vehicle and is a video source, are connected to the gateway unit 3 through the analog lines 33. Video data read in the DVD unit 31 and the navigation unit 32 is relayed at the gateway unit 3 and is sent to the branch network 2.

In the branch network 2, communications between each unit are performed with a transmission bit rate of the order of several hundreds Mbps because each unit is connected by transmission lines comprising the glass optical fiber 21. In the branch network 2, the video data is sent to the optical coupler 22 through the gateway unit 3 and the glass optical fiber 21 and pictures are delivered to the front display unit 23 and the rear display units 24, 25 when the video data is displayed on the front display unit 23, the rear display units 24, 25.

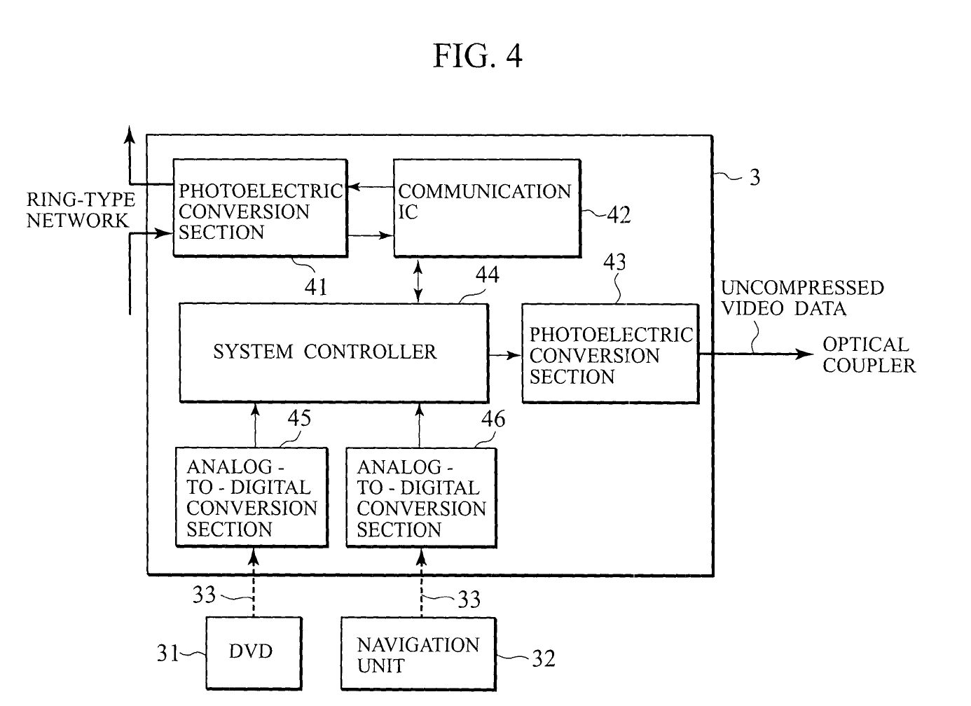

As shown in FIG. 4, the gateway unit 3 comprises a photoelectric conversion section 41 and a communication IC 42, both of which are provided for communication in the ring-type network, for the ring-type network.

The photoelectric conversion section 41 for the ring-type network 1 is provided with a beam-receiving section and a beam-emitting section which are not shown in the drawing. An optical signal sent from an adjacent unit (node) to the photoelectric conversion section 41 in the ring-type network 1 is converted into an electric signal and is fed to the communication IC 42. The electric signal received through the communication IC 42 is converted into an optical signal which is fed to an adjacent unit (not shown in the FIG. 4) in the ring-type network 1. The communication IC 42 performs communication control processing by which packets with a data structure specified by a standard are made for communication in a simultaneous manner with other units in the ring-type network 1.

The gateway unit 3 further comprises: a photoelectric conversion section 43, which communicates with the optical coupler 22 connected to the branch network 2, for the branch network; an analog-to-digital conversion section 45, which communicates with the DVD unit 31 and the navigation unit 32, for the DVD unit; an analog-to-digital conversion section 46 for the navigation unit; and a system controller 44 which controls the above sections 41, 42, 43, 45 and 46.

The photoelectric conversion section 43 for the branch network has a laser unit not shown in the drawings. Video data sent as an electric signal is converted into an optical signal and is sent to the glass optical fiber 21 (optical coupler 22) by driving the laser unit according to the contents of video data sent from the system control section 44.

In the analog-to-digital conversion section 45 for the DVD unit, the video signal from the DVD unit 31 is received through the analog line 33 and the received data is converted into a digital video data for output to the system controller 44. Moreover, in the analog-to-digital conversion section 46 for the navigation unit, the video signal from the navigation unit 32 is received through the analog line 33 and the received data is converted into a digital video data for output to the system controller 44. Here, the data from the DVD unit 31 includes sound data for reproducing sounds corresponding to pictures, other than the video data. Moreover, the data from the navigation unit 32 includes sound data for, for example, vehicle guidance, other than the video data such as map data.

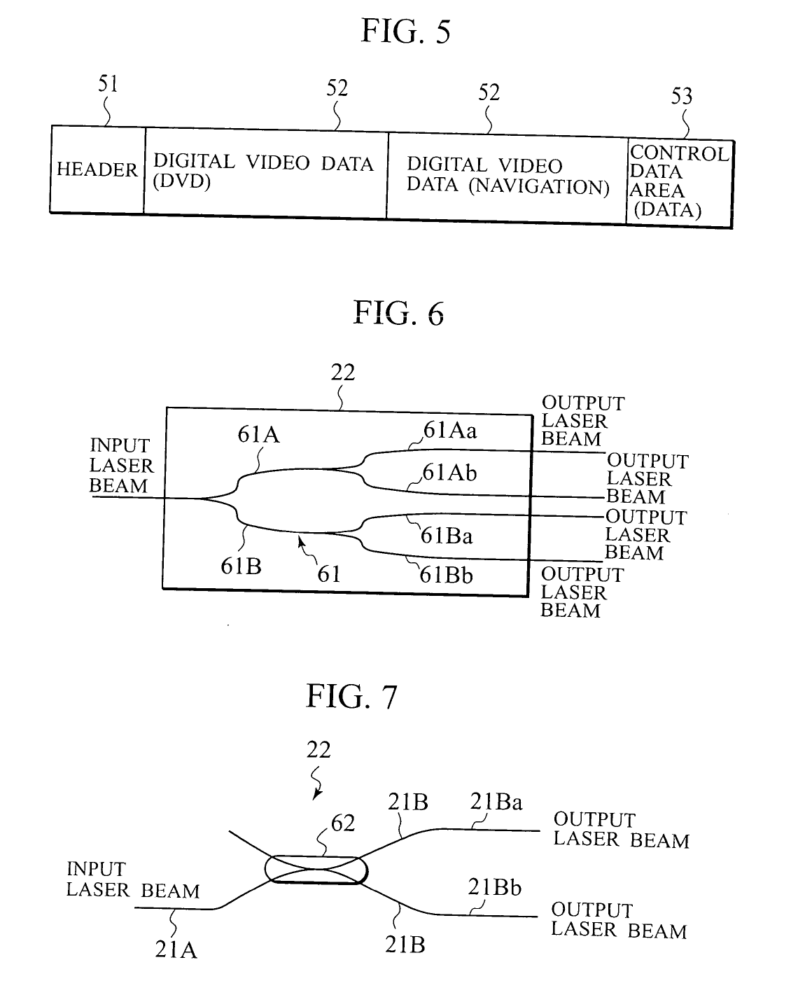

The system controller 44 in the gateway unit 3 makes packets for video data which can be received in the front display unit 23, the rear display units 24, 25, using the video data input from the analog-to-digital conversion section 45 for the DVD unit and the analog-to-digital conversion section 46 for the navigation unit. Data received at the front display unit 23, and the rear display units 24, 25 can be recognized and processed by setting a frame structure of the packets as one shown in FIG. 5.

The system controller 44 stores, for example, information such as a sending end and an address of video data in a header area 51. The video data (digital video data) from the DVD unit 31 and the video data (digital video data) from the navigation unit 32 are stored in a data area 52. Moreover, control data such as switch information corresponding to operation of the head unit 14 in the ring-type network 1 is stored in a control data area 53. The packets made in the system controller 44 is fed to the photoelectric conversion section 43 for the branch network and, then, to the branch network 2.

When the system controller 44 controls the gateway unit 3 so as to send the video data from the DVD unit 31 together with the video data from the navigation unit 32 to the branch network 2, packets for the data from the DVD unit 31 and packets for the data from the navigation unit 32 are alternately made one by one, and these packets are send according to a time sharing method.

Moreover, the system controller 44 output sound data to the communication IC 42 when the sound data is input through the analog-to-digital conversion section 45 for the DVD unit and the analog to digital conversion section 46 for the navigation unit. Then, the communication IC 42 stores the sound data in a packet transmitted on the ring-type network 1 and feeds the data to the amplifier 13 through the photoelectric conversion section 41 for the ring-type network 1 and, the plastic optical fibers 11. Thereby, pictures are displayed at the side of the branch network 2 and, at the same time, sound reproductions corresponding to the pictures are made at the side of the ring-type network 1.

The optical coupler 22 receives packets including the video data from the gateway unit 3 via the glass optical fiber 21 and delivers the packets to the front display unit 23, and the rear display units 24, 25, which are branched from the coupler 22. In the first embodiment, the optical coupler 22 delivers the packets including the same contents to the front display unit 23, and the rear display units 24, 25.

When the optical coupler 22 according to the first embodiment is configured to be of a wave guide type, the coupler 22 is provided with a wave guide 61 so that laser beams input from the gateway unit 3 are received and divided into two laser beams 61A, 61B and the divided laser beams 61A, 61B are further divided into two laser beams, respectively, to obtain four output laser beams 61Aa, 61Ab, 61Ba, and 61Bb, as shown in FIG. 6. Though a configuration in which four output laser beams 61Aa, 61Ab, 61Ba, 61Bb are emitted is described in the first embodiment, another configuration in which further more number of output laser beams are made after dividing for units to be added in the branch network 2 can be applied.

In the optical coupler 22 of a wave guide type, the size of the optical branch part can be reduced, though a space required for wiring the glass optical fiber 21 is needed in case of the coupler is of a later-described fiber fusion-bonding type.

Moreover, since the optical coupler 22 of a wave guide type has the increased degree of freedom in designing of, for example, the branch number of the input laser beams, the branch network 2 with the coupler in an optical junction box can be formed.

And, when the optical coupler 22 is of a fiber fusion-bonding type, there is applied a configuration in which fusion-bonding of other glass fibers 21B, 21B to a glass optical fiber 21A by which the input laser beams from the gateway unit 3 are guided is executed and the input laser beams branch to two output laser beams 21Ba, 21Bb, as shown in FIG. 7. Moreover, the fusion-bonded part between the glass optical fiber 21A and the glass optical fibers 21B, 21B are protected with a protective member 62 (reinforcing member) in this case. The protective member 62 is made of resin material and the like, and is covered with a metal sleeve. Here, a configuration in which fusion-bonding of further more glass fibers 21 to the glass optical fiber 21A and the glass optical fiber 21B is executed to cause further increased number of output laser beams after branching for units to be added in the branch network 2 can be applied, though the case in which two output laser beams are emitted has been described in the present embodiment.

Since branch lines of a laser beam can be easily manufactured and, furthermore, a configuration with reduced cost can be realized when the optical coupler 22 in use is of a fiber fusion-bonding type, the branch network 2 can have a configuration in which the coupler is accommodated in a wire harness of the vehicle.

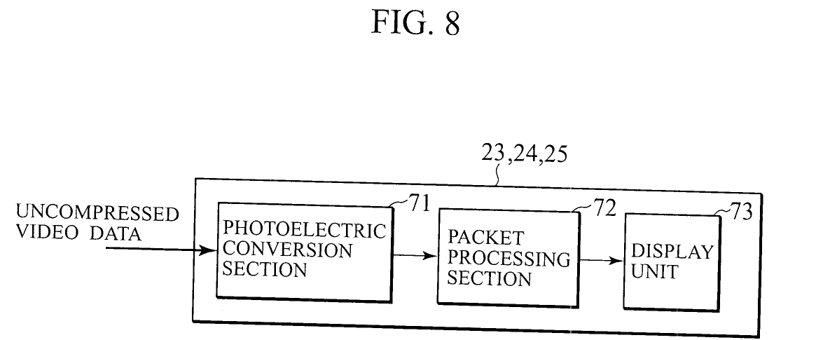

As shown in FIG. 8 the front display unit 23, the rear display units 24, 25 are connected to the optical coupler 22 through the glass fibers 21 and comprise a photoelectric conversion section 71 with abeam receiving section (not shown), a packet processing section 72 and a display unit 73.

When the display units 23, 24, 25 receive an optical signal from the optical coupler 22 at the photoelectric conversion section 71, the optical signal is converted into an electric signal for feeding it to the packet processing section 72. Then, the packet processing section 72 judges whether the packet of the received electric signal is one addressed to the section 72, referring to the header area 51 of the packet of the electric signal which the photoelectric conversion section 71 has sent. When it is recognized that the packet which the packet processing section 72 has received is a packet addressed to the packet processing section 72, the section 72 drives the display unit 73 so that video data is taken out of the data area 52 of the packet for display of a picture.

As explained above, according to the video delivering system S1 for vehicle use of the first embodiment, apart (e.g., in the roof section and the seat sections of the vehicle) in which fiber arrangement in the vehicle is complex can have a configuration using the branch network 2 to cause easy arrangement of wire harnesses in the vehicle, because the system is comprised of the ring-type network 1 in which fiber arrangement in the limited space of the vehicle is complex and the branch network 2 in which fiber arrangement in the vehicle is comparatively easy, and the ring-type network land the branch network 2 are connected to each other through the gateway 3.

Moreover, according to the video delivering system S1 for vehicle use, communication can be maintained by using one of the networks, in which there is no breakdown in communication, even when a breakdown in communication is caused in a certain part of the ring-type network 1 or the branch network 2, and breakdowns in communication among all the components in the system can be avoided, though there is a possibility, in a system comprising only the ring-type network 1, that breakdowns in communication among all the components in the system are caused at disconnection on a part of transmission lines.

When a breakdown in communication is caused in a certain part of the ring-type network 1 or the branch network 2, the gateway unit 3 can notify that a breakdown in communication has been caused, for example, using one of the networks, in which there is no breakdown in communication.

Further, in the system S1, the image compression function and the image expansion one are not required to be installed in the DVD unit 31, the navigation unit 32, and the display units 23 through 25 to realize reduction in the costs of each unit and reproduction of pictures with higher image quality, because the system S1 has a configuration in which the branch network 2 with a higher transmission bit rate than that of the ring-type network 1 is provided in the system S1 and video data is transmitted on the branch network 2.

[Second Embodiment]

Then, a video delivering system S2 for vehicle use according to the second embodiment will be explained. Here, parts similar to those previously described with reference to the first embodiment are denoted by the same reference numbers, and detailed explanation will be omitted. [Configuration of a Video Delivering System for Vehicle use According to the Second Embodiment]

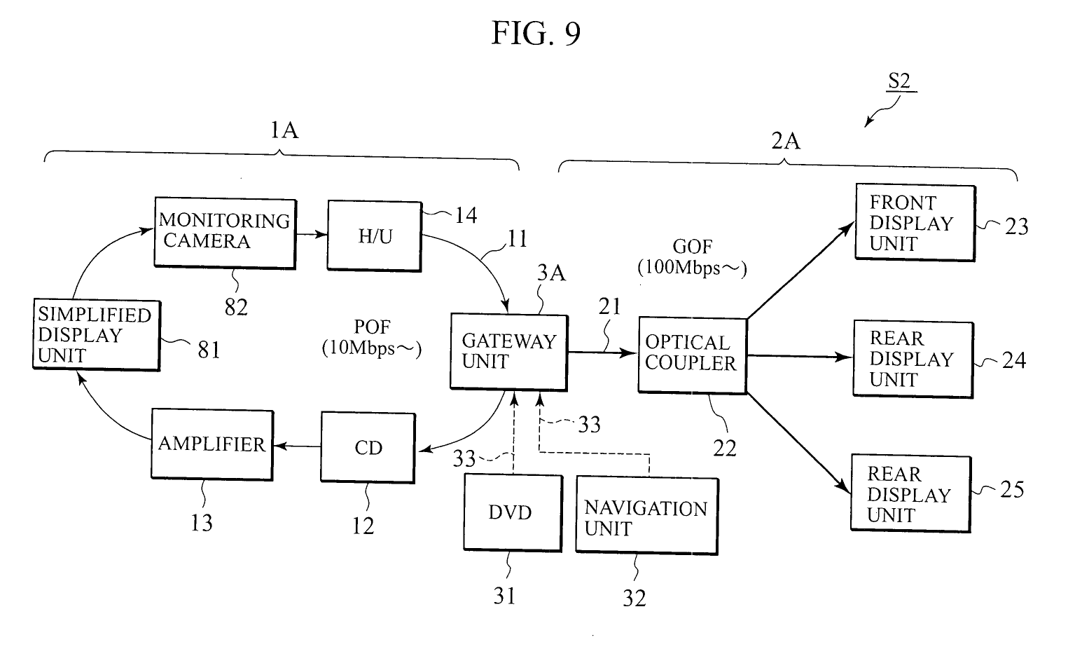

A video delivering system S2 for vehicle use according to the second embodiment is different from the system of the first embodiment in that the system S2 installs an image compression and expansion function in a gateway 3A, and a simplified display unit 81 and a monitoring camera 82 which takes pictures of, for example, the rear side of a vehicle are provided in a ring-type network 1A, as shown in FIG. 9.

In the second embodiment, the simplified display unit 81 displays a picture of the inside of the vehicle from, for example, a back seat. Moreover, the monitoring camera 82 compresses the video data obtained at taking the picture for sending because the transmission bit rate of the ring-type network 1 is low for delivering pictures.

The video delivering system for vehicle use S2 according to the second embodiment has a configuration in which video data from the DVD unit 31 and the navigation unit 32 can be displayed on the simplified display unit 81 and a picture which is taken with the monitoring camera 82 can be displayed on display units 23, 24 and 25.

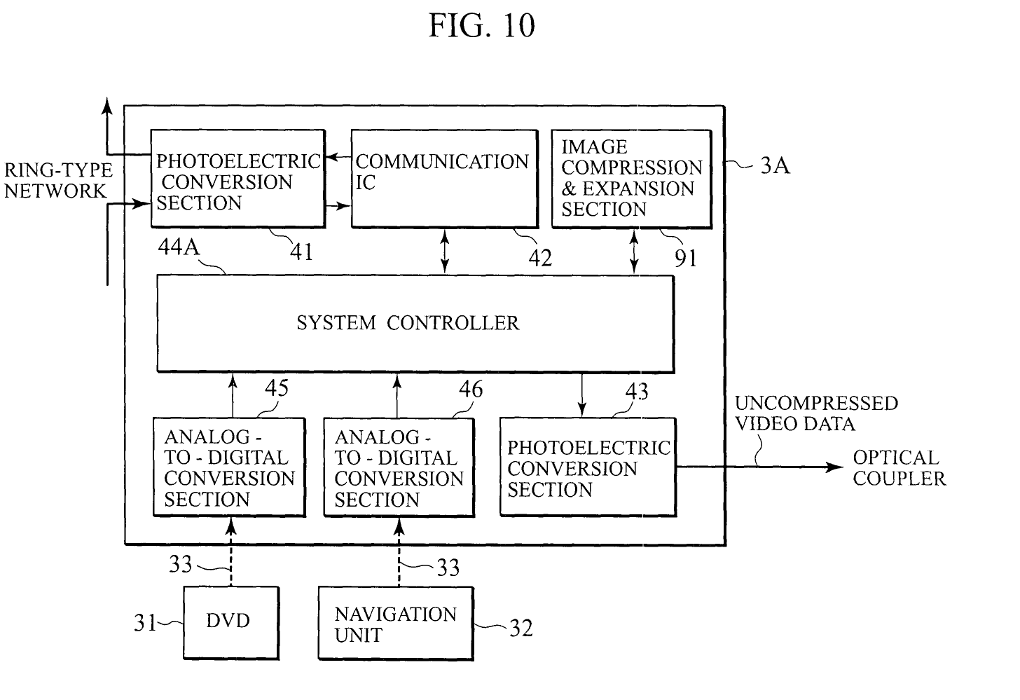

The gateway unit 3A of the system S2 for vehicle use is provided with an image compression and expansion section 91, in addition to the components of the gateway unit 3 of the system S1, and, in the image compression and expansion section 91, compression processing and expansion processing of video data are executed under control of a system controller 44A as shown in FIG. 10. In the image compression and expansion section 91, expansion processing of video data is executed for output to the system controller 44A when compressed video data is input from the system controller 44A, and compression processing of video data is executed for output to the system controller 44A when uncompressed video data is input from the system controller 44A.

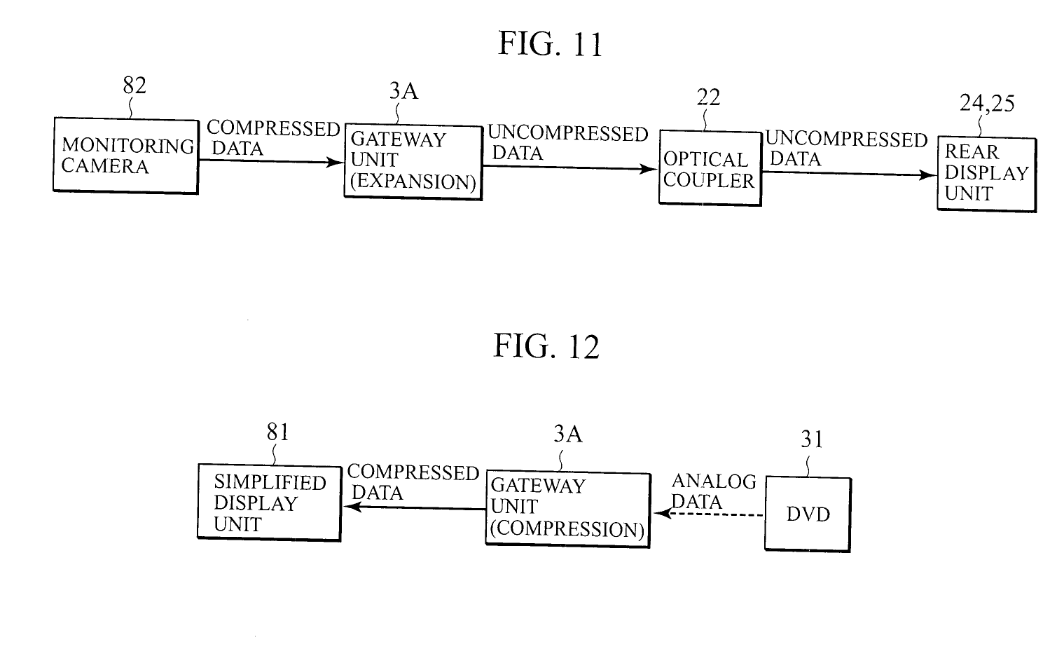

Moreover, as shown in FIG. 11, the image compression and expansion section 91 of the system controller 44A uncompresses a compressed data taken by the monitoring camera 82 to an uncompressed video data which the rear display unit 24 (25) can display. Then, the system controller 44A feeds the uncompressed video data to an optical coupler 22 for display on the rear display unit 24. Here, the above processing is required because the low transmission bit rate of the ring-type network 1A needs compression of the video data which is taken with the monitoring camera 82.

Furthermore, when an instruction (switch information) that a DVD picture and the like is displayed on the simplified display unit 81 is input from a head unit (H/U) 14 to the system controller 44A, video data sent from the DVD unit 31 is compressed in the image compression and expansion section 91 as shown in FIG. 12. Subsequently, the system controller 44A has a configuration in which the compressed video data is fed to the ring-type network 1A through the communication IC 42 and the photoelectric conversion section 41 for the ring-type network 2A and is displayed on the simplified display unit 81. Here, the above processing is required because the slow transmission bit rate of the ring-type network 1A needs compression of data for a DVD picture and the like.

As has been explained above, the system S2 has the following advantages, in addition to those of the video delivering system S1.

According to the video delivering system S2 for vehicle use, the compression function of video data is not required to be installed in the DVD unit 31 and the navigation unit 32 even when uncompressed video data is displayed on the simplified display 81 in the ring-type network 1A. Accordingly, reduction in the costs of units forming the system S2 can be realized.

Moreover, according to the video delivering system S2 for vehicle use, video data is expanded in the gateway unit 3A for display on display units 23 through 25 even when the video data at taking a picture by the side of the ring-type network 1A is compressed. Accordingly, the expansion function of video data is not required to be installed in the display units 23 through 25 and reduction in the costs of the display units 23 through 25 can be realized.

Therefore, according to the video delivering system S2 for vehicle use, a new image compression and expansion function is not required to be added to realize reduction in the cost for addition of units even when another new display unit is added in the ring-type network 1A and the branch network 2A because batch processing for information compression and expansion for transmission of information is executed in the gateway unit.

For example, in a case in which the DVD unit 31 is connected to the ring-type network 1A and compressed video data is memorized in a piece of recording media (e.g., DVD), the compressed video data is expanded in the system controller 44A so that uncompressed video data is made in the image compression and expansion section 91 and the uncompressed video data is sent when the above compressed video data is displayed on the display units 23, 24 and 25. Though an expansion function of the video data is not installed in the display units 23, 24 and 25, the compressed picture can be displayed by the above-described configuration.

[Third Embodiment]

Then, a video delivering system S3 for vehicle use according to the third embodiment will be explained. Here, parts similar to those previously described with reference to the above embodiments are denoted by the same reference numbers, and detailed explanation will be eliminated.

[Configuration of a Video Delivering System for Vehicle use According to the Third Embodiment]

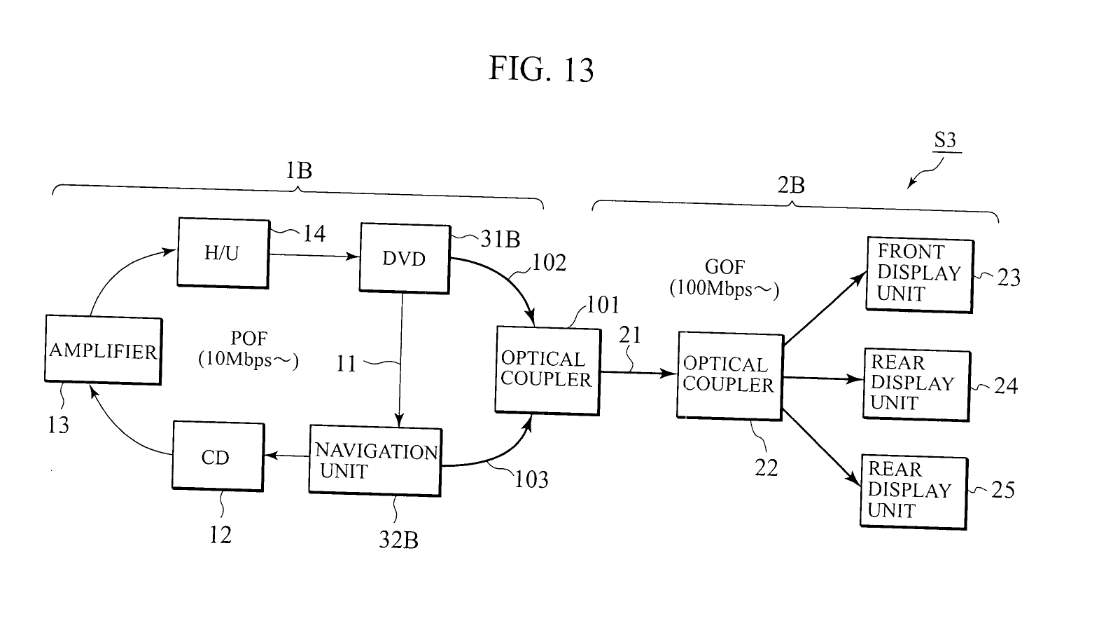

As shown in FIG. 13, the video delivering system S3 for vehicle use according to the third embodiment is different from the systems of the above embodiments in that the above gateway units 3, 3A are not provided, a DVD unit 31B and a navigation unit 32B are included in the side of a ring-type network 1B, and the network 1B comprises a wavelength multiplexing coupler 101 which is connected to the DVD unit 31B, the navigation unit 32B and a branch network 2B.

In the video delivering system S3 for vehicle use, the DVD unit 31B and the navigation unit 32B comprises: a photoelectric conversion section (not shown) for communication in the ring-type network 1B and a communication IC (not shown), and has a function for relaying packets fed from adjacent units.

Moreover, the DVD unit 31B is connected to a glass optical fiber 102 connected to the wavelength multiplexing coupler 101 in order to feed video data to the branch network 2B. And a glass optical fiber 103 connected to the wavelength multiplexing coupler 101 is connected to the navigation unit 32B. Furthermore, each of the DVD unit 31B and the navigation unit 32B has a laser unit (not shown) which makes generated video data to an optical signal for sending it to the wavelength multiplexing coupler 101.

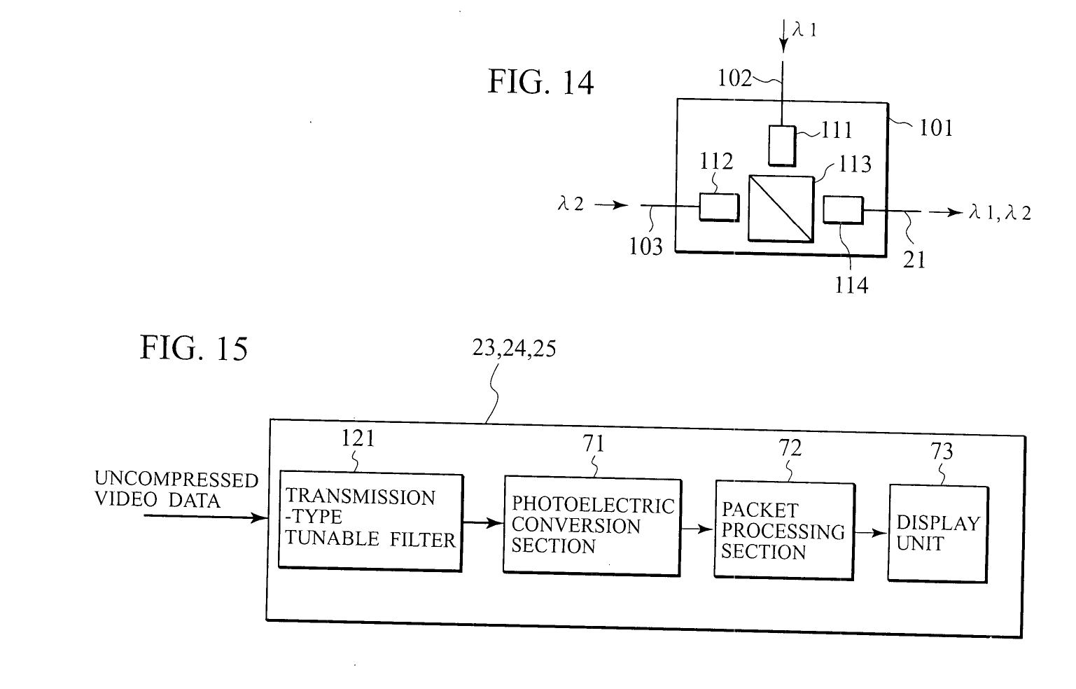

As shown in FIG. 14, the DVD unit 31B outputs an optical signal having a first wavelength λ1 with the built-in laser unit (not shown) and the navigation unit 32B outputs an optical signal having a second wavelength λ2 different from the first wavelength λ1 with the built-in laser unit.

In the wavelength multiplexing coupler 101, the optical signal of the first wavelength λ1 fed from the DVD unit 31B via the glass optical fiber 102 enters through a collimator lens 111 and the optical signal of the second wavelength λ2 fed from the navigation unit 32B through the glass optical fiber 103 enters through a collimator lens 112. The optical signal of the first wavelength λ1 is made into parallel rays with the collimator lens 111 and the rays are guided to a beam splitter 113 with a filter (not shown). Furthermore, the optical signal of the second wavelength λ2 is made into parallel rays with the collimator lens 112 and the rays are guided to the beam splitter 113 with a filter.

Multiplexing processing of the optical signal of the first wavelength λ1 and the optical signal of the second wavelength λ2 is executed in the beam splitter 113. The filter of the beam splitter 113 has a high-pass filter, a low-pass filter or a band-pass filter, which passes signals of the first wavelength λ1 and the wavelength λ2.

An optical signal emitted from the beam splitter 113 is guided to a collimator lens 114 for feeding it to the glass optical fiber 21. Thereby, an optical signal including the first wavelength λ1 and the second wavelength λ2 is fed to the display units 23, 24 and 25 through the branch optical coupler 22.

As shown in FIG. 15, the display units 23, 24 and 25 receives the optical signal fed via the wavelength multiplexing coupler 101 through the branch optical coupler 22, using a transmission-type tunable filter 121. According to a control signal, for example, from the head unit 14, the transmission-type tunable filter 121 selects a wave length to be passed.

Thereby, in the transmission-type tunable filter 121, an optical signal of the first wave length λ1 or that of the second wave length λ2 is selected and is converted into an electric signal, which is fed to a photoelectric conversion section 71 for display of a DVD picture or a navigation picture.

Here, in the video delivering system S3 for vehicle use, the DVD unit 31 or the navigation unit 32 may be provided with a function which expands compressed video data sent from the monitoring camera 82 when the simplified display 81 and the monitoring camera 82 are provided in the ring-type network 1B. Moreover, the DVD unit 31 or the navigation unit 32 maybe provided with a function which compresses video data when a DVD data and a navigation data is displayed on the simplified display 81.

As explained above, the system S3 attains the following advantages, in addition to those of the above-described embodiments.

That is, according to the video delivering system S3 for vehicle use, a gateway-unit part between the ring-type network 1B and the branch network 2B can be simplified to realize reduction in the cost of the system because the system has a configuration in which the wavelength multiplexing coupler 101 is provided between the ring-type network 1B and the branch network 2B, and the video data multiplexed by the wavelength multiplexing coupler 101 is delivered to the display units 23, 24 and 25.

Here, the above-described embodiments are examples of the invention. Accordingly, the invention is not limited to the above-described embodiments. And, obviously, various modifications corresponding to designing and the like, other than the above embodiments, may occur without departing from the scope of the technical ideas according to the invention.

What is claimed is:

1. A video delivering system for vehicle use comprising:
a video generation unit which generates video data;
a ring-type network which is connected to the video generation unit, and in which a video delivering device for sending and receiving data to and from the video generation unit and a plurality of units connected to the video delivering device are connected with one another in a ring shape and data is sent and received between the units adjacent to each other; and
a branch network which is connected to the video delivering device, and in which video data generated in the video generation unit is sent to at least one of video display units through the video delivering device.

2. The video delivering system for vehicle use of claim 1, wherein
in the ring-type network, data is sent and received at a predetermined transmission bit rate and, in the branch network, data is sent and received at a higher transmission bit rate than that of the ring-type network; and
the video delivering device delivers uncompressed video data from the video generation unit through the branch network to the video display unit and sound data corresponding to the relevant video data is delivered from the video generation unit to a sound output unit through the ring-type network.

3. The video delivering system for vehicle use of claim 2, wherein
the video generation unit comprises: a first video generation unit which sends first video data to the video delivering device; and a second video generation unit which delivers second video data to the video delivering device, and the video delivering device delivers the first video data and the second video data to the video display unit according to a time division multiplexing method, and delivers a first sound data corresponding to the first video data and a second sound data corresponding to the second video data to the sound output unit, and
the video display unit displays the first video data or the second video data, and, at the same time, the sound output unit reproduces sounds by fetching the first or second sound data corresponding to the first or second video data fetched in the video display unit.

4. The video delivering system for vehicle use of claim 1, wherein
the ring-type network further comprises at least one of video display units, and
the video delivering device is provided with compression and expansion means for compressing or expanding video data, and delivers compressed video data generated in the video generation unit to the video display unit in the branch network after expansion processing of the compressed video data and, at the same time, uncompressed video data to the video display unit in the ring-type network after compression processing of the uncompressed video data.

5. A video delivering system for vehicle use, comprising:
a ring-type network in which a plurality of units including a video generation unit which generates video data are connected with one another in a ring shape and data is sent and received between the units adjacent to each other;
a wavelength multiplexing coupler which multiplexes a plurality of kinds of video data, which have been fed from the video generation unit as an optical signal, for output; and
a branch network comprising: a branch coupler which is connected to the wavelength multiplexing coupler and divides beams input from the wavelength multiplexing coupler; and at least one of video display units, which are branched from the branch coupler and display video data generated in the video generation unit.

6. The video delivering system for vehicle use of claim 5, wherein the ring-type network comprises: a sending/receiving means for sending and receiving data between units adjacent to each other; and a converting means for feeding video data input from the video generation unit to the wavelength multiplexing coupler as an optical signal.

7. A video delivering system for vehicle use, comprising:
video-data input means which inputs video data from a video generation unit for generating the video data;
first communication means which is connected to a ring-type network in which a plurality of units are connected with one another in a ring shape, and sends and receives data between the units adjacent to each other; and
second communication means which is connected to the first communication means and to a branch network in which a plurality of units are branched from the second communication means and sends video data input in the video data input means to at least one of video display units in the branch network.

8. The video delivering system for vehicle use of claim 7, wherein
the second communication means sends and receives data at a predetermined transmission bit rate and delivers uncompressed video data input with the video data input means to the video display unit through the branch network, and
the first communication means sends and receives data between units at a lower transmission bit rate than the predetermined transmission bit rate and delivers sound data corresponding to the video data, which has been delivered to the branch network, from the video generation unit to a sound output unit through the ring-type network.

9. The video delivering system for vehicle use of claim 8, wherein
the second communication means delivers a plurality of kinds of video data to the video display unit according to a time division multiplexing method, and the first communication means delivers sound data corresponding to the plurality of kinds of video data to the sound output unit when the plurality of kinds of video data from a plurality of video generation units are delivered.

10. The video delivering system for vehicle use of claim 8, further comprising
compression and expansion means by which expansion processing of compressed video data from the video generation unit included in the ring-type network is executed and the compressed video data is delivered to the video display unit included in the branch network by the second communication means, and, at the same time, compression processing of uncompressed video data is executed and the uncompressed video data is delivered to the video display unit included in the ring-type network by the first communication means.
